(19) United States
(12) Patent Application Publication
(10) Pub. No.: US 2011/0129748 A1
(43) Pub. Date: Jun. 2, 2011

(54) OPERATIONAL METHOD OF FUEL CELL

(75) Inventors: Wei-Kai Chang, Taoyuan County (TW); Chien-Ping Yeh, Taoyuan County (TW); Po-Shao Tung, Taoyuan County (TW); Chiang-Wen Lai, Taoyuan County (TW)

(73) Assignee: NAN YA PCB CORP., TAOYUAN COUNTY (TW)

(21) Appl. No.: 12/698,060

(22) Filed: Feb. 1, 2010

(30) Foreign Application Priority Data
Dec. 1, 2009 (TW) 98140955

(51) Int. Cl. H01M 8/04

(52) U.S. Cl. 429/432

(57) ABSTRACT

According to embodiments of the invention, an operational method of a fuel cell is provided. The method includes providing a fuel cell used to provide output power to a load, measuring an initial average voltage of the output power provided by the fuel cell, measuring a first average voltage of the output power after the output power has been provided to the load by the fuel cell for a first time interval, and stopping the fuel cell from providing output power to the load when a voltage difference between the initial average voltage and the first average voltage is more than a first allowable voltage difference.

### CROSS REFERENCE

This Application claims priority of Taiwan Patent Application No. 098140955, filed on Dec. 1, 2009, the entirety of which is incorporated by reference herein.

### BACKGROUND OF THE INVENTION

1. Field of the Invention

The present invention relates to an operational method of a fuel cell, and in particular relates to an operational method of a direct oxidation fuel cell.

2. Description of the Related Art

Due to the gradual depletion of conventional fossil fuels and the environmental impact caused by using fossil fuels, the development of alternative energy sources with low pollution and high electrical efficiency is becoming more and more important.

Among the many kinds of new energy sources being developed, such as solar cells, bioenergy, or fuel cells, fuel cells have attracted much attention due to their high electrical efficiency and low pollution. In contrast to thermal electric power which uses fossil fuel, which also requires multiple energy transformation steps, the chemical energy of fuel cells can be converted directly into electrical energy. By using a catalytic electrode, the reaction rate between the fuel of the fuel cell, such as hydrogen, and the oxidant, such as oxygen, may be improved. The efficiency of the fuel cell is much higher than that of energy sources which are produced by thermal electric power. Further, the by-product of the fuel cell is essentially water, which does not harm the environment.

In a fuel cell, a catalyst consisting of a noble metal is usually used to enhance electrical efficiency. For example, platinum is often used as a catalyst in a heterogeneous catalytic reaction. After a fuel cell is operated for a period of time, the catalytic ability of the catalyst will be degraded, leading to degraded electrical efficiency of the fuel cell because the surface of the catalyst may be poisoned by other compounds in the reactive environment. It may also become covered by deposits or other residue which is formed during reaction. Taking a direct methanol fuel cell as an example, some methanol may penetrate through an electrolyte of a membrane electrode assembly due to diffusion or electro-osmotic drag. Thus, methanol may reach a cathode side and poison the catalyst in the cathode. When the catalytic electrode of the fuel cell is over poisoned, permanent damage may occur and the performance and lifespan of the fuel cell will be decreased. In addition, for a direct methanol fuel cell, gas from carbon dioxide generated from the anode side may be absorbed on the surface of the catalytic electrode to reduce reaction area of the catalytic electrode, thereby lowering performance of the fuel cell.

Thus, to adequately employ a fuel cell and maintain its stable performance, a novel operational method for a fuel cell is desired.

### BRIEF SUMMARY OF THE INVENTION

According to an illustrative embodiment of the invention, an operational method of a fuel cell is provided. The method includes providing a fuel cell to provide an output power to a load, measuring an initial average voltage of the output power provided by the fuel cell, measuring a first average voltage of the output power after the output power has been provided to the load by the fuel cell for a first time interval, and stopping the fuel cell from providing the output power to the load when a voltage difference between the initial average voltage and the first average voltage is more than a first allowable voltage difference.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing a fuel cell system according to an embodiment of the present invention;

FIGS. 2a and 2b together show a supply chart of an operational method of a fuel cell according to an embodiment of the present invention; and

FIG. 3 is a schematic diagram showing a fuel cell system according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is understood, that the following disclosure provides many different embodiments, or examples, for implementing different features of the invention. Specific examples of components and arrangements are described below to simplify the present disclosure. These are, of course, merely examples and are not intended to be limiting.

An embodiment of the invention provides an operational method of a fuel cell. An average voltage provided by a fuel cell is measured and compared with an initial average voltage. When a voltage difference between the measured average voltage and the initial average voltage is more than a predetermined value, an output power providing by the fuel cell is terminated temporarily to prevent a catalytic electrode of the fuel cell from being further poisoned and to recover performance of the fuel cell.

Before describing embodiments of the present invention, an operational method of a fuel cell known by the inventor is described. In this method, an output power source providing energy to a fuel cell is terminated periodically after a predetermined time interval. After the output power provided to the fuel cell is terminated, the function of a poisoned catalytic electrode may be recovered gradually and the occurrence of poison may be eliminated gradually.

However, it is noted by the inventor that the method mentioned above cannot employ a fuel cell adequately and can not ensure the fuel cell from being over poisoned. For example, when a fuel cell works well, it should be capable of operating for a longer time. However, in this method, the output power provided to the fuel cell is still terminated periodically, thus lowering electrical efficiency of the fuel cell. On the other hand, when a fuel cell works relatively poorly, the fuel cell still continues to provide output power until the next “shutdown” period is reached. The catalytic electrode may be further poisoned during this period. It is even possible that the catalytic electrode may be damaged permanently, thus lowering performance and lifespan of the fuel cell.

In order to employ a fuel cell adequately and protect the fuel cell from being over poisoned, embodiments of the invention are provided. In one embodiment, voltages of the fuel cell are measured. When performance of the fuel cell is lowered to a specific degree, the fuel cell stops providing electrical power temporarily, such that the poisoned catalytic electrode may be timely recovered to prevent the catalytic electrode from being over poisoned. Not only is the electrical efficiency of the fuel cell employed effectively, the catalytic electrode of the fuel cell is also protected against being permanently damaged. Performance and lifespan of the fuel cell is thus significantly improved.

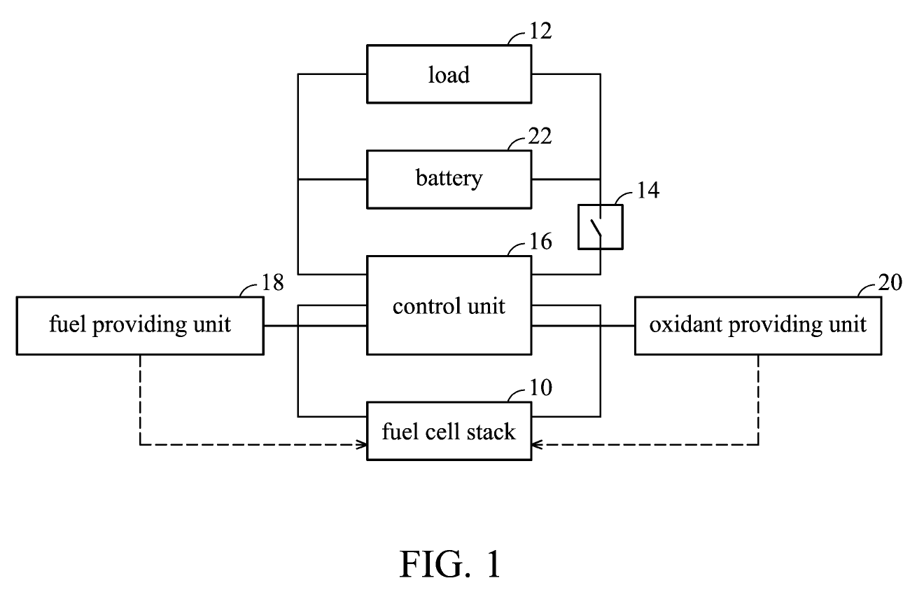

FIG. 1 is a schematic diagram showing a fuel cell system according to an embodiment of the present invention, which is used to illustrate an operational method of a fuel cell according to an embodiment of the present invention. However, it should be appreciated that the operational method of the fuel cell mentioned in embodiments of the invention is not limited to be performed under system shown in FIG. 1. One skilled in the art should understand that system shown in FIG. 1 is merely an example for illustration. The operational method of a fuel cell according to an embodiment of the invention may be performed under another fuel cell system.

Referring to FIG. 1, in this fuel cell system, a fuel cell stack 10 is used to provide an output power to a load 12. The fuel cell stack 10 includes a plurality of fuel cell membrane electrode assemblies, which are electrically connected in series to each other, for providing a desired voltage. The number of the fuel cell membrane electrode assemblies may be varied depending on requirement. The load 12 may be any electronic product which consumes electrical energy. In the embodiments of the invention, the fuel cell stack 10 is usually a direct oxidation fuel cell stack, such as a direct methanol fuel cell.

As shown in FIG. 1, the fuel cell system includes a fuel providing unit 18 and an oxidant providing unit 20, which are used to provide a fuel such as methanol and an oxidant such as air or oxygen to the fuel cell stack 10, respectively. The fuel cell further includes a control unit 16, a switch 14, and a battery 22. The fuel providing of the fuel providing unit 18 and the oxidant providing of the oxidant providing unit 20 are controlled by the control unit 16. Through the switch 14, whether the fuel cell stack 10 provides the output power to the load 12 is controlled by the control unit 16. For example, when performance of the fuel cell is degraded, the switch 14 may be opened to stop the fuel cell stack 10 from continuing providing the output power to the load 12. Meanwhile, the fuel provided to an anode of the fuel cell stack 10 may be decreased or stopped. The oxidant provided to a cathode of the fuel cell stack 10 may also be stopped. During the period when the fuel cell stack 10 stops providing the output power, the battery 22 electrically parallel with the load 12 may be used to provide an electrical source to the load temporarily such that the load 12 may keep working. When the fuel cell stack 10 stops providing the output power, the fuel inside the fuel cell stack 10 may diffuse to the catalytic electrodes. When the fuel cell stack 10 is not in operation, the poisoned catalytic electrode may react with the fuel and be recovered gradually, lowering or eliminating the degree of poison on the catalytic electrode. Thereafter, the fuel provided to the anode of the fuel cell stack 10 may be re-increased or re-started. The oxidant provided to the cathode of the fuel cell stack 10 may be re-started. The output power providing to the load 12 may be re-started.

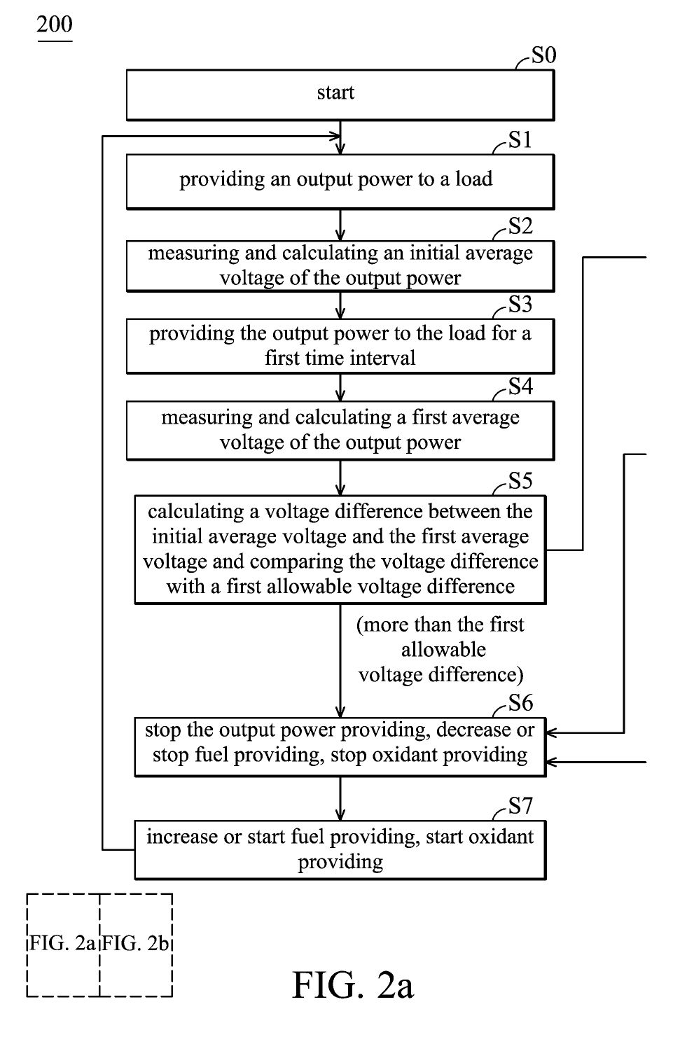

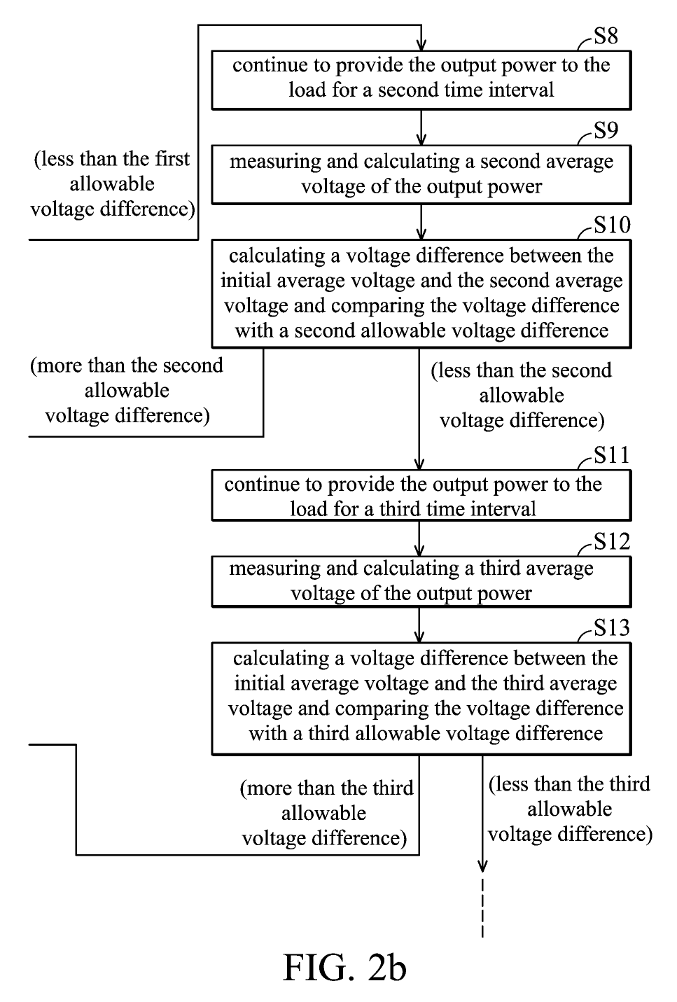

In the following description, an operational method 200, for a fuel cell according to an embodiment of the present invention is illustrated in more detail with references made to the supply chart shown in FIGS. 2a and 2b. The method 200 begins with step S0. A fuel cell system is established first. For example, a system such as, but not limited to, that shown in FIG. 1 may be established.

Then, the method 200 continues with step S1 in which an output power is provided to a load. Then, step S2 is performed to measure an initial average voltage of the output power. Typically, voltages of the output power are relatively unstable when the fuel cell starts working. Thus, the initial average voltage of the output power is usually measured and calculated after the fuel cell operates for a period of time. For example, the initial average voltage of the output power of the fuel cell may be measured and calculated after the fuel cell starts to provide the output power for about, but not limited to, one minute. One skilled in the art should understand that when the initial average voltage is measured and calculated, it may be varied according to the situation. For example, the initial average voltage may be measured and calculated after the fuel cell provides the output power for 0.5, 2, or 3 minutes. The initial average voltage may be determined by measuring a plurality of voltage values at different moments in a period of time. An average of these measured voltage values is the initial average voltage of the fuel cell. For example, the output power may be measured every second for 5 seconds. The obtained 5 voltage values are averaged to determine the initial average voltage of the fuel cell. In another example, the output power may be measured every 2 seconds for 10 seconds. The obtained voltage values are averaged to determine the initial average voltage of the fuel cell. The initial average voltage of a fuel cell may be determined by another method according to the situation, not limited to the examples mentioned above.

Method 200 continues with step S3 in which the output power continues providing to the load for a first time interval. In step S4, after the first time interval passes, a first average voltage of the output power is measured. For example, a method similar to the method used to determine the initial average voltage may be applied to measure and calculate the first average voltage of the output power. The first time interval may be adjusted according to the situation. For example, after step S2 is finished, the first average voltage may be measured and calculated after providing the output power to the load for, but is not limited to, about 9 minutes. In another example, after step S2 is finished, the first average voltage may be measured and calculated after providing the output power to the load for about 15 minutes. The first time interval may be adjusted according to different situations. Typically, when the fuel cell is operating in an application where the fuel cell may be over poisoned easily, it is preferable to use a relatively short first time interval. When the fuel cell is operating in an application where the fuel cell may not be over poisoned easily, a relatively long first time interval may be applied.

Method 200 continues with step S5 in which a voltage difference between the initial average voltage and the first average voltage is calculated and compared with a first allowable voltage difference. When the voltage difference between the initial average voltage and the first average voltage is more than the first allowable voltage difference, the output power of the fuel cell may have been substantially degraded or even degraded beyond an allowable degree. In this state, the catalytic electrode of the fuel cell may be poisoned to a specific degree such that the voltage difference between the first average voltage and the initial average voltage is too much (over the first allowable voltage difference). In order to prevent the poisoned catalytic electrode from becoming further poisoned and suffering damage that cannot be reversed, it is necessary to stop the fuel cell from providing output power to the load.

In step S6, because the voltage difference between the initial average voltage and the first average voltage is more than the first allowable voltage difference, the fuel cell is stopped from providing the output power to the load. Therefore, before the catalytic electrode of the fuel cell is severely poisoned, the partially poisoned catalytic electrode may be recovered gradually to reduce or eliminate further poisoning of the fuel cell. This effectively improves the lifespan of the fuel cell. In addition, to ensure smooth recovery of the fuel cell, the fuel supply may be decreased or stopped and the oxidant supply may also be stopped.

Then, after the recovery of the fuel cell is substantially completed, step S7 may be performed where the fuel and oxidant supply is re-initiated or increased. The recovered fuel cell may begin providing output power to the load again. In another word, after step S7, the method 200 re-begins with step S1.

In the method mentioned above, the value of the first allowable voltage difference may be adjusted according to different situations. Typically, when the fuel cell is operated in an application where the fuel cell may be over poisoned easily, it is preferable to use a relatively low first allowable voltage difference. Thus, the voltage difference between the initial average voltage and the first average voltage may exceed the first allowable voltage difference more readily and step S6 is therefore performed more frequently. The recovery procedure of the fuel cell is thus performed more frequently to prevent an over poisoning from occurring. On the contrary, when the fuel cell is operated in an application where the fuel cell may not be over poisoned easily, a relatively high first allowable voltage difference may be applied. Thus, the fuel cell may be employed adequately and the electrical efficiency of the fuel cell is improved.

Usually, for a single fuel cell membrane electrode assembly, the output power prior to poisoning is about 0.5 volt. When the voltage of the output power is degraded to about 0.3 volt, the single fuel cell membrane electrode assembly may be regarded as being poisoned to the point where it is not suitable for continuous operations. The supply of output power should be terminated to prevent over-poisoning. In this situation, it is possible to set the first allowable voltage difference to 0.2 volt. Once it is found that the voltage decreases by over 0.2 volts, the output power provided by the fuel cell should be stopped so that the fuel cell may be recovered. It should be appreciated, however, that the first allowable voltage difference is not limited to be 0.2 volts. For a single fuel cell membrane electrode assembly, the first allowable voltage difference may range between, but is not limited to, about 0.011 volts and 0.2 volts.

Moreover, for a fuel cell stack, because it includes a plurality of single fuel cell membrane electrode assemblies electrically connected in series with each other, a relatively high first allowable voltage difference may be applied. For a fuel cell stack, the first allowable voltage difference may be, but is not limited to, a multiple of the first allowable voltage difference of the single fuel cell membrane electrode assembly. For example, for a fuel cell stack including 20 single fuel cell membrane electrode assemblies electrically connected in series with each other, the first allowable voltage difference may range between, but is not limited to, about 0.22 volts and 4 volts. In addition, depending on different material systems of the fuel cell, different applications, different loads, and/or different operational environments, such as with temperature differences, the first allowable voltage difference may be adjusted accordingly.

In step S5, as mentioned above, when the voltage difference between the initial average voltage and the first average voltage is more than the first allowable voltage difference, the method 200 should continue with step S6. However, in another case, when the voltage difference between the initial average voltage and the first average voltage is less than the first allowable voltage difference, the method 200 should continue with step S8, in which the fuel cell continues to provide the output power to the load for a second time interval. In this case, because the voltage of the output power of the fuel cell is not degraded too much, performance of the fuel cell is still good and the fuel cell is not over poisoned. Thus, the fuel cell continues to provide the output power to the load to obtain a better electrical efficiency. Similarly, the second time interval may be adjusted according to the situation. For example, the second time interval may be, but is not limited to, about 2 minutes. In another example, the second time interval may be, but is not limited to, about 3 minutes.

Method 200 continues with step S9 in which a second average voltage of the output power of the fuel cell is measured and calculated. The second average voltage may be measured by a method similar to that used for measuring the first average voltage.

Method 200 then continues with step S10 in which a voltage difference between the initial average voltage and the second average voltage is calculated and compared with a second allowable voltage difference. The second allowable voltage difference needs to be no more than the first allowable voltage difference. In one embodiment, the second allowable voltage difference equals the first allowable voltage difference. In another embodiment, the second allowable voltage difference is less than the first allowable voltage difference. Typically, when the fuel cell operates to step S10, the output power provided has been continuously supplied for a period of time such that the catalytic electrode of the fuel cell may have been poisoned to a specific degree. At this moment, to ensure that the fuel cell is not over poisoned, it is preferable to use a second allowable voltage difference less than the first allowable voltage difference such that the fuel cell may be recovered more timely.

When the voltage difference between the initial average voltage and the second average voltage is more than the second allowable voltage difference, the output power of the fuel cell is degraded beyond an allowable degree. In order to prevent the poisoned catalytic electrode from being further poisoned and suffering irreversible damage, the output power provided to the load of the fuel cell should be stopped. Thus, the method 200 needs to revert back to step S6 to make sure the fuel cell can be recovered. In addition, after recovery, the method 200 may continue with step S7 and then the output power provided to the load may be re-started.

Similarly, in step S10, in another case, when the voltage difference between the initial average voltage and the second average voltage is less than the second allowable voltage difference, the method 200 continues with step S11 in which the fuel cell continues to provide output power to the load for a third time interval. In this case, because the voltage of the output power of the fuel cell is not degraded too much, performance of the fuel cell is still good and the fuel cell is not severely poisoned. Thus, the fuel cell continues to provide the output power to the load to obtain a better electrical efficiency. Similarly, the third time interval may be adjusted according to the situation. For example, the third time interval may be, but is not limited to, about 2 minutes. In another example, the third time interval may be, but is not limited to, about 3 minutes.

Similarly, the method 200 continues with step S12 in which a third average voltage of the output power is measured and calculated. Then, the method 200 continues with step S13 in which a voltage difference between the initial average voltage and the third average voltage is calculated and compared with a third allowable voltage difference. When the voltage difference between the initial average voltage and the third average voltage is more than the third allowable voltage difference, it appears that the catalytic electrode of the fuel cell is getting over poisoned. The method 200 needs to proceed back with step S6 to make sure the fuel cell is being recovered timely. After being recovered, method 200 may continue with step S7 and the output power provided to the load may be re-started.

The third allowable voltage difference needs to be no more than the second allowable voltage difference. In one embodiment, the third allowable voltage difference equals the second allowable voltage difference. In another embodiment, the third allowable voltage difference is less than the second allowable voltage difference. Typically, when the fuel cell operates to step S13, the output power provided has been continued for a period of time such that the catalytic electrode of the fuel cell may have been poisoned to a specific degree. At this moment, to ensure that the fuel cell is not over poisoned, it is preferable to use a third allowable voltage difference less than the second allowable voltage difference so that the fuel cell may be recovered more timely.

Similarly, in step S13, when the voltage difference between the initial average voltage and the third average voltage is less than the third allowable voltage difference, the fuel cell may continue to provide power. By similar methods, a fourth allowable voltage difference or even a fifth allowable voltage difference may be set. Thus, the fuel cell may continue to provide output power when it works well, thus improving electrical efficiency of the fuel cell. Further, the fuel cell may be timely and quickly recovered before it is over-poisoned, thus increasing lifespan of the fuel cell.

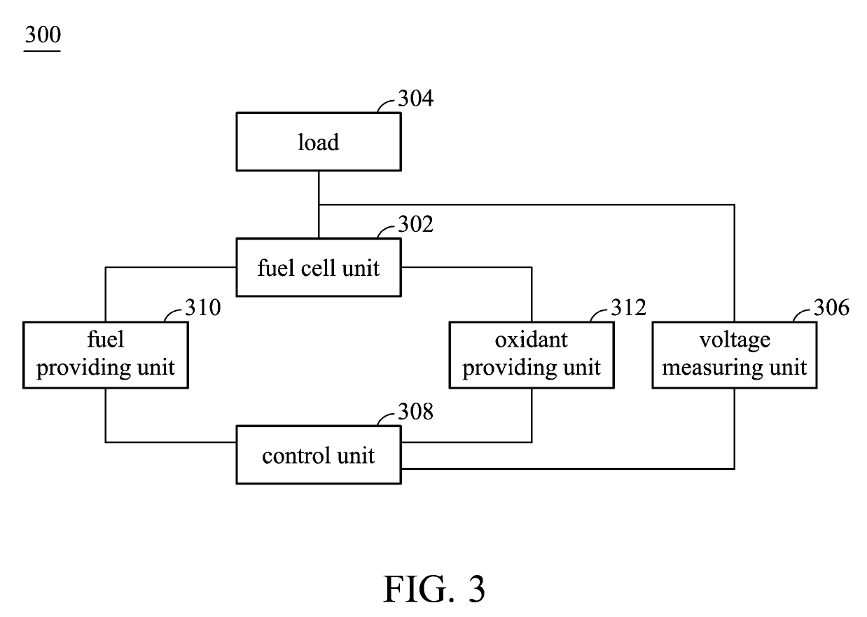

FIG. 3 is a schematic diagram showing a fuel cell system 300 according to an embodiment of the present invention. System 300 adapts to perform an operational method of a fuel cell according to an embodiment of the invention, such as method 200 shown in FIGS. 2a and 2b.

System 300 includes a fuel cell unit 302 used to provide an output power to a load 304. System 300 includes a voltage measuring unit 306 used to measure a plurality of voltages of the output power at different moments. System 300 includes a control unit 308 used to determine an initial average voltage of the output power of the fuel cell unit 302 according to a portion of the voltages measured by the voltage measuring unit 306. After the initial average voltage is determined, the control unit 308 can determine an average voltage of the output power according to a portion of the voltages measured by the voltage measuring unit 306. The control unit 308 further calculates a voltage difference between the initial average voltage and the average voltage. For example, the control unit 308 may calculate a voltage difference between the initial average voltage and the first average voltage (or the second or third average voltage). When the voltage difference is more than an allowable voltage difference such as the first allowable voltage difference, the control unit 308 further stops the fuel cell unit 302 from providing output power to the load 304. Thus, the fuel cell unit 302 may be recovered timely.

In addition, as shown in FIG. 3, system 300 may further include a fuel providing unit 310 and an oxidant providing unit 312, which are used to provide fuel to an anode of the fuel cell unit 302 and provide an oxidant to a cathode of the fuel cell unit 302, respectively. Wherein, the fuel providing unit 310 and the oxidant providing unit 312 are controlled by the control unit 308. When the voltage difference is more than the allowable voltage difference, the control unit 308 may make the fuel providing unit 310 stop or decrease the fuel supply. The control unit 308 may also make the oxidant providing unit 312 to stop the oxidant providing. In one embodiment, system 300 may further include a battery. When the fuel cell unit 302 stops providing the output power to the load 304, the battery may be used to provide power to the load temporarily. For example, the battery may be, but is not limited to, connecting to the load 304 in a way similar to that shown in FIG. 1.

In embodiments of the present invention, performance of the fuel cell is monitored. Thus, the supply of energy from the fuel cell can be stopped at a suitable moment and thus be recovered timely. Both good electrical efficiency and long lifespan of the fuel cell are achieved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An operational method of a fuel cell, comprising:
providing a fuel cell used to provide an output power to a load;
measuring an initial average voltage of the output power provided by the fuel cell;
measuring a first average voltage of the output power after the output power has been provided to the load by the fuel cell for a first time interval; and
stopping the fuel cell from providing the output power to the load when a voltage difference between the initial average voltage and the first average voltage is more than a first allowable voltage difference.

2. The operational method of a fuel cell as claimed in claim 1, further comprising:
providing a fuel to an anode of the fuel cell; and
providing an oxidant to a cathode of the fuel cell.

3. The operational method of a fuel cell as claimed in claim 2, wherein the fuel is provided by a fuel providing unit, and the oxidant is provided by an oxidant providing unit.

4. The operational method of a fuel cell as claimed in claim 2, further comprising decreasing or stopping the fuel providing to the anode of the fuel cell when the voltage difference between the initial average voltage and the first average voltage is more than the first allowable voltage difference.

5. The operational method of a fuel cell as claimed in claim 4, further comprising increasing or starting the fuel providing to the anode of the fuel cell after decreasing or stopping the fuel providing to the anode of the fuel cell.

6. The operational method of a fuel cell as claimed in claim 2, further comprising stopping the oxidant providing to the cathode of the fuel cell when the voltage difference between the initial average voltage and the first average voltage is more than the first allowable voltage difference.

7. The operational method of a fuel cell as claimed in claim 6, further comprising starting the oxidant providing to the cathode of the fuel cell after stopping the oxidant providing to the cathode of the fuel cell.

8. The operational method of a fuel cell as claimed in claim 1, further comprising starting providing the output power to the load after stopping the fuel cell from providing the output power to the load.

9. The operational method of a fuel cell as claimed in claim 1, further comprising:
when the voltage difference between the initial average voltage and the first average voltage is less than the first allowable voltage difference, the fuel cell is made to continue providing the output power to the load;
after the output power is continuously provided for a second time interval, measuring a second average voltage of the output power; and
when a voltage difference between the initial average voltage and the second average voltage is more than the second allowable voltage difference, stopping the fuel cell from providing the output power to the load, wherein the second allowable voltage difference is no more than the first allowable voltage difference.

10. The operational method of a fuel cell as claimed in claim 9, wherein the second allowable voltage difference is less than the first allowable voltage difference.

11. The operational method of a fuel cell as claimed in claim 9, wherein the second allowable voltage difference equals to the first allowable voltage difference.

12. The operational method of a fuel cell as claimed in claim 9, further comprises re-initiating the providing of the output power to the load after the fuel cell has been instructed to stop providing the output power to the load.

13. The operational method of a fuel cell as claimed in claim 9, further comprising:
when the voltage difference between the initial average voltage and the second average voltage is less than the second allowable voltage difference, making the fuel cell to continue providing the output power to the load;
after the output power is continuously provided for a third time interval, measuring a third average voltage of the output power; and
when a voltage difference between the initial average voltage and the third average voltage is more than a third allowable voltage difference, stopping the fuel cell from providing the output power to the load, wherein the third allowable voltage difference is no more than the second allowable voltage difference.

14. The operational method of a fuel cell as claimed in claim 13, further comprising re-starting the providing of output power to the load after the fuel cell has been instructed to stop providing the output power to the load.

15. The operational method of a fuel cell as claimed in claim 1, wherein the fuel cell is a single fuel cell membrane electrode assembly and the first allowable voltage difference ranges between 0.011 volt and 0.2 volt.

16. The operational method of a fuel cell as claimed in claim 1, wherein the fuel cell is a direct oxidation fuel cell.

17. The operational method of a fuel cell as claimed in claim 1, further comprising providing a battery, wherein when the fuel cell is instructed to stop providing the output power to the load, the battery is alternatively used to provide the output power to the load.

18. The operational method of a fuel cell as claimed in claim 1, wherein the initial average voltage and the first average voltage of the output power are measured by a voltage measuring unit.

19. The operational method of a fuel cell as claimed in claim 1, further comprising:
using a control unit and a voltage measuring unit to determine the initial average voltage and the first average voltage of the output power;
calculating a voltage difference between the initial average voltage and the first average voltage by the control unit; and
stopping the fuel cell from providing the output power to the load when the voltage difference between the initial average voltage and the first average voltage is more than the first allowable voltage difference by the control unit.
